(19) United States
(12) Patent Application Publication
(10) Pub. No.: US 2024/0110675 A1
(43) Pub. Date: Apr. 4, 2024

(54) ILLUMINATION DEVICE WITH OPTIMIZED COLOR GAMUT

(71) Applicant: Schott AG, Mainz (DE)

(72) Inventors: Albrecht Seidl, Mainz (DE); Volker Hagemann, Mainz (DE)

(73) Assignee: Schott AG, Mainz (DE)

(21) Appl. No.: 18/478,136

(22) Filed: Sep. 29, 2023

(30) Foreign Application Priority Data
Sep. 29, 2022 (DE) 10 2022 125 141.1

(51) Int. Cl. F21K 9/64; F21V 9/40

(52) U.S. Cl. CPC F21K 9/64; F21V 9/40

(57) ABSTRACT

An illumination device includes: a light source configured for emitting a primary light; a light conversion unit formed by or including a light conversion element including a front side and a back side, the light conversion element being configured for being illuminated with the primary light and for emitting a secondary light with a wavelength altered relative to the primary light, the light conversion element being configured, on illumination with the primary light, for emitting the secondary light which is characterized by a spectrum which defines a point in a CIE 1931 color space at least one of that: (i) together with a blue point and a red point of an REC709 window defines an area which covers at least 95% of the REC709 window; and (ii) has a radial distance from a green point of the REC709 window that is at most 0.02.

### CROSS REFERENCE TO RELATED APPLICATIONS

This claims priority to German patent application no. 10 2022 125 141.1, filed Sep. 29, 2022, which is incorporated herein by reference.

### BACKGROUND OF THE INVENTION

### 1. Field of the Invention

The present invention relates to an illumination device, and, more particularly, to an illumination device for an electronic apparatus.

### 2. Description of the Related Art

The color locus of light is frequently indicated in the CIE 1931 color space. The CIE color space represents the entirety of the colors perceptible for a human, in an xy coordinate system. With regard to the reproduction of color by electronic apparatus such as projectors or screens, for example, it is possible in turn within the CIE 1931 color space to specify color loci for the colors red, green and blue, corresponding to a red point, green point and blue point, respectively.

Depending on materials of the light conversion element and on the primary light irradiated, therefore, it is possible to target and attain specific color loci in the CIE color space for the secondary light emitted. In practice, however, differences between the mandated target and the color locus actually obtained are difficult to avoid. Color correction can be performed using optical filters, by filtering out parts of the secondary light emitted. This may, however, be to the detriment of the efficiency or efficacy of the illumination device.

What is needed in the art is an illumination device, and a light conversion unit for an illumination device, that exhibit color-optimized properties for electronic apparatus such as projectors or screens, and characteristics targeted particularly in this context are sufficiently good conversion properties, high efficiency or efficacy, and acceptable negative thermal quenching (NQT) at elevated temperatures. What is also needed in the art is for there to be no need for optical filters for color correction.

### SUMMARY OF THE INVENTION

The invention relates to an illumination device having a light source for emitting primary light and a light conversion element which receives the primary light and emits secondary light with an altered color locus.

The present invention provides an illumination device including a light source for emitting primary light, embodied more particularly as a laser, the light source being optionally embodied for emitting primary light with a wavelength in the range from 400 nm to 460 nm, optionally in the range from 448 nm to 455 nm, e.g. 450 nm.

The illumination device of the present invention further includes a light conversion unit formed by or including a light conversion element having a front side and a back side. At its most simple, therefore, the light conversion unit may be embodied as the light conversion element itself or may optionally include further components, as is set out in more detail later on below.

In any case, the light conversion element is configured to be illuminated with the primary light and to emit secondary light. Relative to the primary light, the secondary light optionally has at least an altered wavelength and more particularly an altered color locus relative to the primary light.

On illumination with the primary light, more particularly with the wavelength in the range from 400 nm to 460 nm, optionally in the range from 448 nm to 455 nm, e.g. 450 nm, the light conversion element is able optionally to emit secondary light which is characterized by a spectrum that defines a particular point in the CIE 1931 color space.

This point is optionally notable in that (i) together with the blue point and the red point of the REC709 window, it defines an area which covers at least 95% of the REC709 window, optionally at least 96%, optionally at least 97%, and/or (ii) has a radial distance from the green point of the REC709 window that is at most 0.02, optionally at most 0.015, optionally at most 0.01.

The REC709 window or the REC709 color gamut defines a particular region within the CIE 1931 color space. For this, three color loci in the blue, red and green regions are stipulated as vertices of the region. The REC709 region is represented in FIG. 3, which is addressed in more detail later on below.

The secondary light which the light conversion element is able to emit on irradiation with the primary light is detectable experimentally. For determining the color locus, the light conversion element can be excited with the primary light, more particularly with the wavelength in the range from 400 nm to 460 nm, optionally in the range from 448 nm to 455 nm, e.g. 450 nm, and the light emitted can be measured spectrally using a spectrometer.

For determining the color locus from a spectrum measurable in this way, in particular only the part of the measured spectrum starting from a wavelength of 465 nm is utilized. In particular, therefore, in the context of this invention, the spectrum characterizing the secondary light is understood as the spectrum starting from a wavelength of 465 nm. With this definition of the emission spectrum, moreover, it is possible advantageously to prevent diffusely reflected primary light being included in the secondary light on measurement, as set out in more detail later on below.

Surprisingly it has been found that the color locus of the secondary light may be dependent on the thickness of the light conversion element. The thickness of the light conversion element refers to its dimension extending from the front side to the back side.

In one optional embodiment, this thickness is between 50 μm and 250 μm, optionally between 70 μm and 250 μm, optionally still between 80 μm and 150 μm or between 70 μm and 115 μm.

The color locus of the secondary light is also dependent in particular on the material of the light conversion element.

In one optional embodiment, the light conversion element includes a light-converting ceramic material.

In one optional embodiment, the light conversion element includes the material (Lu₁₋ₓCeₓ)3(Al_{1-y}Ga_{y})5O₁₂, where 0<x<0.01 and 0<y<0.2, optionally 0<x<0.007 and 0<y<0.15. The light conversion element consists optionally predominantly, optionally completely, of this material.

The illumination device of the present invention is suitable particularly for reflectance geometry, but may also have a transmittance geometry.

Accordingly, for example, the light conversion element may be configured to be illuminated with the primary light on its front side and to emit the secondary light on its front side. This case may be understood as reflectance geometry.

As well as the light conversion element, the light conversion unit may optionally further include a substrate which is connected directly or indirectly to the back side of the light conversion element and is embodied optionally as a heat sink.

Further, the light conversion unit may optionally include a connector which is located between the light conversion element and the substrate and connects them to one another.

It is also possible, for example, for the light conversion element to be configured to be illuminated with the primary light on its back side and to emit the secondary light on its front side. This case may be understood as transmittance geometry.

In certain embodiments, the light conversion unit and/or the light conversion element may be embodied as a ring or ring segment, more particularly be embodied as a ring wafer.

The light conversion unit and/or the light conversion element may optionally have an outer diameter which is larger than 30 mm and optionally smaller than 120 mm.

In certain embodiments, the light conversion unit may have at least one highly reflective coating, the highly reflective coating optionally being a metallic coating and/or a dielectric coating, optionally an Ag or Ag-containing coating.

In certain embodiments, the connector may be embodied as a metallic solder or as a sintered sinter paste or adhesive, wherein the solder optionally has a melting point below 300° C. and also optionally includes or consists of an Au/Sn solder and/or AuSn8020.

In certain embodiments, the light conversion element includes a multiplicity of pores.

The light conversion element may more particularly have a porosity of between 2% and 12%, optionally between 4% and 8%.

The present invention further relates to a light conversion unit formed by or including a light conversion element having a front side and a back side, the light conversion element being configured to be illuminated with the primary light and to emit secondary light with at least one wavelength altered relative to the primary light.

The light conversion element is optionally embodied, on illumination with the primary light, more particularly with the wavelength in the range from 400 nm to 460 nm, optionally in the range from 448 nm to 455 nm, e.g. 450 nm, to emit secondary light which is characterized by a spectrum which defines a particular point in the CIE 1931 color space.

This point is optionally notable in that (i) together with the blue point and the red point of the REC709 window, it defines an area which covers at least 95% of the REC709 window, optionally at least 96%, optionally at least 97%, and/or (ii) it has a radial distance from the green point of the REC709 window that is at most 0.02, optionally at most 0.015, optionally at most 0.01.

The light conversion unit optionally includes a substrate which is connected directly or indirectly to the back side of the light conversion element and is embodied optionally as a heat sink.

Further, the light conversion unit optionally includes a connector which is located between the light conversion element and the substrate and connects them to one another.

In one optional embodiment, the light conversion element has a thickness of between 50 μm and 250 μm, optionally between 70 μm and 250 μm, optionally still between 80 μm and 150 μm or between 70 μm and 115 μm.

In one optional embodiment, the light conversion element includes a light-converting ceramic material.

In one optional embodiment, the light conversion element includes the material (Lu₁₋ₓCeₓ)3(Al_{1-y}Ga_{y})5O₁₂, where 0<x<0.01 and 0<y<0.2, optionally 0<x<0.007 and 0<y<0.15. The light conversion element consists optionally predominantly, optionally completely, of this material.

The light conversion element may be configured to be illuminated with the primary light on its front side and to emit the secondary light on its front side.

Alternatively, the light conversion element may be configured to be illuminated with the primary light on its back side and to emit the secondary light on its front side.

In certain embodiments, the light conversion unit and/or the light conversion element may be embodied as a ring or ring segment, more particularly embodied as a ring wafer.

The light conversion unit and/or the light conversion element may optionally have an outer diameter which is larger than 30 mm and optionally smaller than 120 mm.

In certain embodiments, the light conversion unit may have at least one highly reflective coating, the highly reflective coating being optionally a metallic coating and/or a dielectric coating, optionally an Ag or Ag-containing coating.

In certain embodiments, the connector may be embodied as metallic solder or as a sintered sinter paste or adhesive, wherein the solder optionally has a melting point below 300° C. and also optionally includes or consists of an Au/Sn solder and/or AuSn8020.

In certain embodiments, the light conversion element includes a multiplicity of pores.

The light conversion element may more particularly have a porosity of between 2% and 12%, optionally between 4% and 8%.

### BRIEF DESCRIPTION OF THE DRAWINGS

by way offhe above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic representation, in section, of an illumination device, additionally showing a measurement with a detector for diffusely emitted converted radiation and a detector for specularly reflected radiation;

FIG. 2 shows a schematic representation, in section, of a light conversion unit having a substrate and a connector;

FIG. 3 shows a representation of the CIE 1931 color space and of the REC709 window and also two color loci A, B of emitted secondary light for two different light conversion elements;

FIGS. 4 and 5 show representations of the CIE 1931 color space and of the REC709 window and also two color loci A, B of emitted secondary light for two different light conversion elements, and a representation of an area showing the coverage of the REC709 window;

FIGS. 6 and 7 show representations of the CIE 1931 color space and of the REC709 window and also three color loci A, B, C of emitted secondary light for three different light conversion elements, and a representation of an area which in contrast to FIGS. 4 and 5 shows the coverage of the REC709 window only for the color locus C (FIG. 7); and

FIG. 8 shows representations of color loci for emission color loci of different Ce-doped, ceramic garnet materials of defined thickness, relative to the REC709 window.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

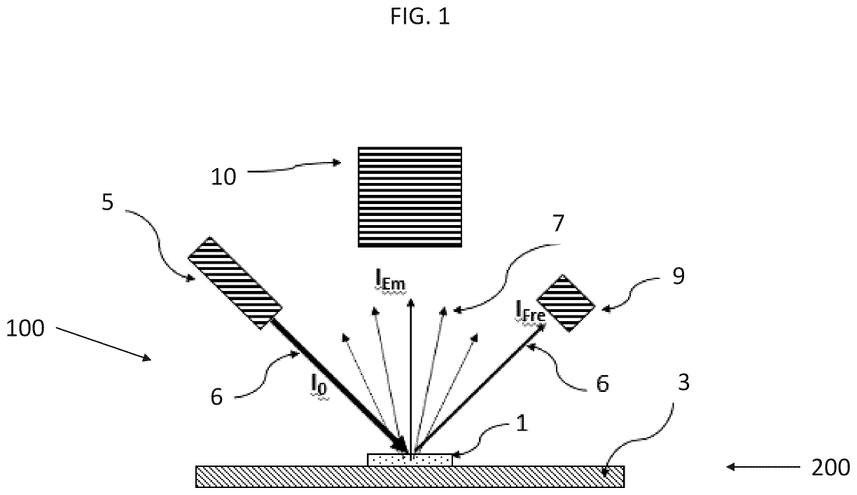

FIG. 1 shows an illumination device 100 together with a measuring system including detectors 9 and 10 which are described in more detail below and which should not be understood as part of the illumination device 100.

The illumination device 100 includes a light conversion unit 200, in this case having a light conversion element 1 and a substrate 3 embodied, for example, as a mirror; a primary light source 5, for example a blue laser beam source, in particular with beam shaping, which is configured to emit a laser beam 6 that strikes the front side of the light conversion element 1, so that secondary radiation 7 develops in the form of diffusely emitted converted radiation. In addition, specularly Fresnel-reflected laser radiation 6 may occur.

With the measuring system shown, it is possible in particular to measure the emission spectrum and to determine from it an emission color locus. The detector 9 is a detector for the specularly reflected radiation. The detector 10 is a detector for the diffusely emitted converted radiation.

According to one example, for instance, a double-sidedly polished converter material of defined thickness may be placed onto a minor having a reflectivity in the visible spectrum of more than 95%. Excitation may take place by blue light with a wavelength of 448-455 nm. The light emitted may then be measured spectrally by way of a spectrometer. For determining the color locus from the spectrum, it is possible more particularly to use the range starting from a wavelength of 465 nm.

The emission spectrum may therefore be regarded in particular as the emitted spectrum starting from a 465 nm wavelength. With this definition, it is possible in particular to ensure that specularly or diffusely reflected excitation light does not enter into the emission spectrum.

With the experimental set-up, it is also possible in particular to determine the efficacy. For this purpose, in an example, double-sidedly polished wafers or wafer rings of defined thickness may again be placed onto a mirror having a reflectivity in the visible spectrum of more than 95%. The converter material may be irradiated with a blue laser beam of such low output or irradiance that there is no significant accompanying heating of the component (a few mW/mm²). The irradiation with intensity I₀ takes place, in particular, obliquely, allowing the specularly reflected Fresnel radiation with intensity I_{Fre} to be measured. The irradiated intensity I₀ is also known through a separate measurement. Moreover, the intensity of the emission spectrum I_{Em} (starting from 465 nm) may be measured by a further detector. The efficacy η is then calculated as η=J_{Em}/(I₀-I_{Fre}), where J_{Em} is the photometric luminous flux corresponding to I_{Em}.

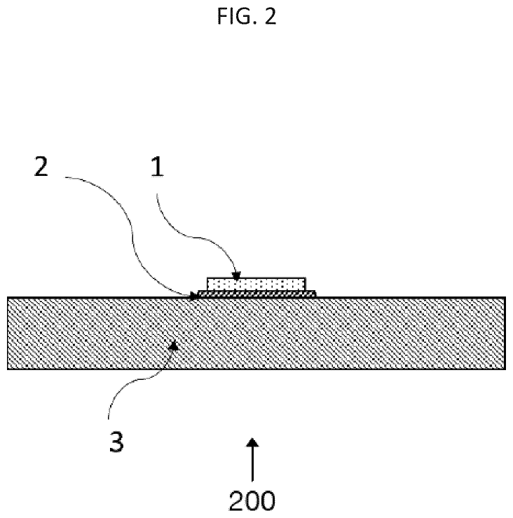

FIG. 2 shows a light conversion unit 200 having a light conversion element 1, a substrate 3 and a connector 2. The light conversion element 1 may be embodied in particular as a ceramic converter. The connector may be embodied, for example, as solder, adhesive, or sintered sinter paste. The substrate may be embodied, for example, as a heatsink, with or of copper, for example, or as a “wheel” with or of aluminium.

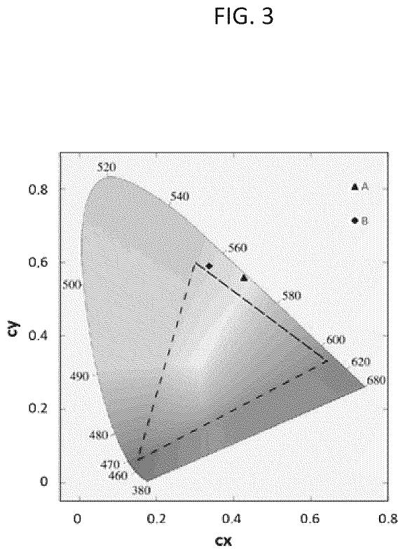

FIG. 3 shows measured emission color loci of two Ce-doped, ceramic garnet materials, which can be used for example for light conversion in projectors, the materials taking the form of thin, double-sidedly polished rings of defined thickness, presently 225 μm, applied to mirrored substrates, and shows their position relative to the REC709 window, represented in the CIE 1931 color space.

The two materials in question are (Y₁₋ₓCeₓ)₃Al₅O₁₂ (YAG:Ce), or else (Lu₁₋ₓCeₓ)₃Al₅O₁₂ (LuAG:Ce). The emission color loci of these converters are red-shifted to a greater or lesser extent, as seen relative to the green point of the REC709 window.

In other words, the pure, unfiltered emission spectra of these Ce-doped garnet materials have an emission color locus which is at a greater or lesser distance from the green point of the REC709 window. This leads to a non-optimal filling of this color space. In order to shift the color locus to the vicinity of the green point, it is indeed possible optionally to filter out parts of the spectrum; below, however, another solution is set out.

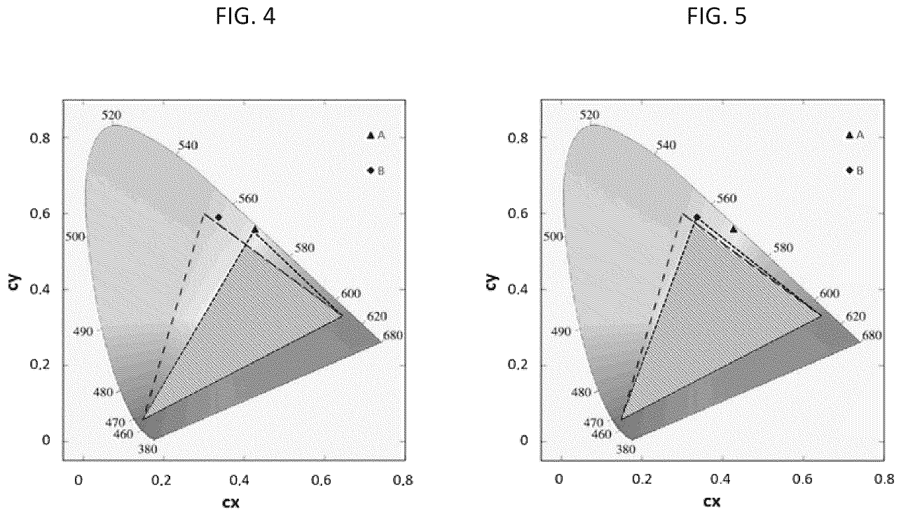

FIGS. 4 and 5 show the merely partial filling of the REC709 window by the stated converters, as the shaded area.

It is possible in particular to provide a criterion of the percentage to which the REC709 region in the CIE 1931 color space is filled by a color region defined with the actual converter material (at the green point), this criterion being referred to below as the fill factor (FF). According to this definition, the maximum FF is 1. The red point and the blue point below are, in particular, the corresponding color loci of the REC709 window.

A further criterion provided is the extent to which the emission color locus in the CIE 1931 color space is radially distant from the green point of the REC709 window. This distance will be referred to here as green distance (GD) and is calculated according to the relationship GD=((cx₇₀₉−cxₑₘ)²+(cy₇₀₉−cyₑₘ)²)^{0.5}. In this relationship, cx₇₀₉ and cy₇₀₉ denote the color coordinates of the green REC709 vertex, and cx em and cy em denote the color coordinates of the converter.

One solution according to the present invention is that the emission color locus even in unfiltered form comes as close as possible to the green point of the REC709 window on excitation by a blue laser with wavelength at 450 nm.

Efficiency or efficacy and also negative thermal quenching (NQT) at elevated temperatures are factors influencing the “irradiance limit”, i.e. the maximum possible excitation intensity with a blue laser.

In one advantageous embodiment, by adding a certain fraction of gallium to the garnet lattice and at the same time adapting the Ce content and also the thickness of the converter, a ceramic garnet material of defined composition and thickness has been specified.

With a partial replacement of Al with Ga in YAG, LuAG or similar garnet host lattices, it is possible to influence the energy level of the Ce3+ in the host lattice such that the emission spectrum shows a more or less strong blue shift. This measure, however, may possibly not be sufficient to achieve an optimum approximation to the green point in the REC709.

Surprisingly it has been found that the exact shape and position of the emission spectrum (and hence of the emission color locus) of a converter material of this kind are dependent not only on the composition of the host material but also on the Ce concentration, and on the thickness of the converter as well.

One optional embodiment includes, for example, the material (Lu₁₋ₓCeₓ)3(Al_{1-y}Ga_{y})₅O₁₂, with a defined range for x and y, and a defined thickness.

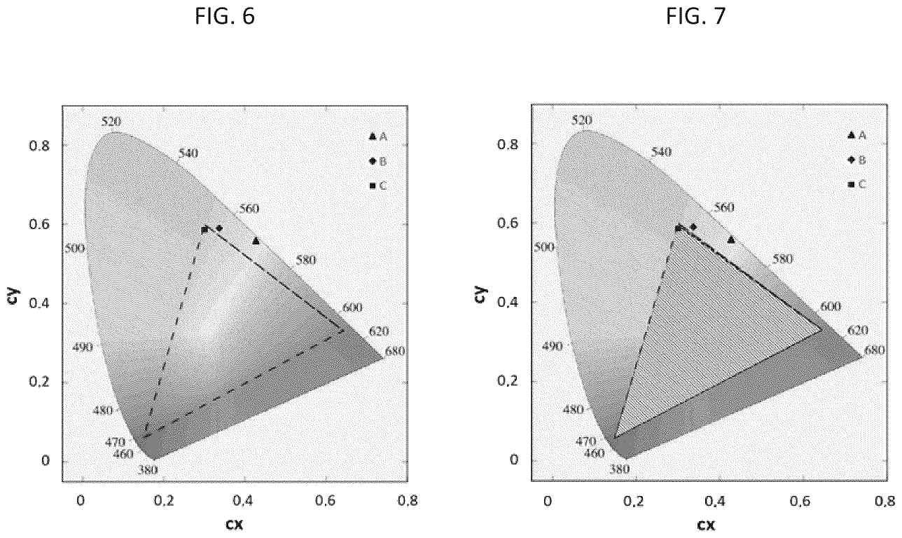

In FIGS. 6 and 7, this working example is shown as color locus C. The color loci shown are measured emission color loci A, B of the two aforementioned, Ce-doped, ceramic garnet materials, in the form of thin, double-sidedly polished rings of defined thickness (here: 225 μm) applied to mirrored substrates, and a color locus C of a component having the composition (Lu₁₋ₓCeₓ)3(Al₁₋ₜGa_{y})₅O₁₂, and its position in the REC709, represented in the CIE 1931 color space, is also shown. FIG. 7 illustrates the particularly effective filling of the REC709 window by the converter C.

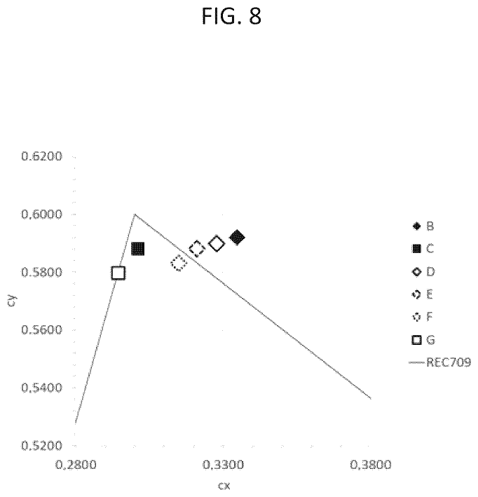

FIG. 8 shows a detail of the CIE 1931 color space with the green corner of the REC709 window and with the position of the emission color loci of various examples from the following table. This table contains examples for measured emission color loci of different Ce-doped ceramic garnet materials of defined thickness, and also the measured efficacy, together with the distance GD from the REC709 green point, and the fill factor FF. Additionally set out are the color coordinates of the REC709 window.

| | | | | thickness | cx | cy | efficacy | | |
|---|---|---|---|---|---|---|---|---|---|
| Example | Composition | x | y | [μm] | emission | emission | [lm/W] | GD | FF |
| A | (Y₁₋ₓCeₓ)₃Al₅O₁₂ | 0.0036 | 0 | 225 | 0.4167 | 0.5593 | 322.0 | 0.124 | 0.705 |
| B | (Lu₁₋ₓCeₓ)₃Al₅O₁₂ | 0.005 | 0 | 225 | 0.3347 | 0.592 | 343.2 | 0.036 | 0.910 |
| C | (Lu₁₋ₓCeₓ)₃(Al_{1-y}Ga_{y})₅O₁₂ | 0.0036 | 0.1 | 225 | 0.3012 | 0.5879 | 340.8 | 0.012 | 0.972 |
| D | (Lu₁₋ₓCeₓ)₃Al₅O₁₂ | 0.005 | 0 | 80 | 0.3278 | 0.5898 | 327.0 | 0.030 | 0.925 |
| E | (Lu₁₋ₓCeₓ)₃Al₅O₁₂ | 0.0036 | 0 | 80 | 0.3211 | 0.588 | 320.1 | 0.024 | 0.941 |
| F | (Lu₁₋ₓCeₓ)₃Al₅O₁₂ | 0.002 | 0 | 80 | 0.3149 | 0.5831 | 300.8 | 0.023 | 0.945 |
| G | (Lu₁₋ₓCeₓ)₃(Al_{1-y}Ga_{y})₅O₁₂ | 0.0036 | 0.1 | 80 | 0.2946 | 0.5795 | 315.4 | 0.021 | 0.962 |
| REC709 G | | | | | 0.30 | 0.60 | | | |
| REC709 B | | | | | 0.15 | 0.06 | | | |
| REC709 R | | | | | 0.64 | 0.33 | | | |

It is evident from FIG. 8 that working example C comes closest to the RE709 green point. Working example G differs from C in the lower thickness of 80 μm by comparison with 225 μm. In order to come closer to the REC709 green point again at this low thickness, it is possible, for example, to reduce the Ga content y and/or to increase the Ce content x.

For the production of example C, respective powders of the pure oxides lutetium oxide, aluminium oxide, gallium oxide and cerium oxide were mixed in accordance with the composition stated in Table 1 for the compound (Lu_{0.9964}Ce_{0.0036})₃(Al_{0.9}Ga_{0.1})₅O₁₂ and, following addition of ethanol and dispersing and pressing assistants, grinding beads were added and the mixture was finely ground in a drum, using a roller bed. The slip was then dried using a rotary evaporator, after which it was pressed uniaxially into hollow-cylindrical green bodies. The green bodies were debinderized at around 600° C., followed by reactive sintering in air at around 1600° C. (for several hours). The sintered bodies were sawn into wafer rings, using a wire saw, and then ground and polished to a thickness of 225 μm.

For the measurement of the emission spectrum, the double-sidedly polished wafer or wafer rings of defined thickness were placed onto a minor having a reflectivity in the visible spectrum of more than 95%. Excitation takes place by blue laser light with a wavelength of 450 nm. The light emitted was measured spectrally by way of a spectrometer; for determining the color locus from the spectrum, the region starting from a wavelength of 465 nm is used.

For measuring the efficacy, the double-sidedly polished wafer or wafer rings of defined thickness were placed onto a mirror having a reflectivity in the visible spectrum of around 98%. Excitation takes place by blue laser light with a wavelength of 450 nm and a power of 3 mW.

For the production of example G, respective powders of the pure oxides lutetium oxide, aluminium oxide, gallium oxide and cerium oxide were mixed in accordance with the composition stated in Table 1 for the compound (Lu_{0.9964}Ce_{0.0036})₃(Al_{0.9}Ga_{0.1})₅O₁₂ and, following addition of ethanol and dispersing and pressing assistants, grinding beads were added and the mixture was finely ground in a drum, using a roller bed. The slip was then dried using a rotary evaporator, after which it was pressed uniaxially into hollow-cylindrical green bodies. The green bodies were debinderized at around 600° C., followed by reactive sintering in air at around 1600° C. (for several hours). The sintered bodies were sawn into wafer rings, using a wire saw, and then ground and polished to a thickness of 80 μm.

For the measurement of the emission spectrum, the double-sidedly polished wafer or wafer rings of defined thickness were placed onto a minor having a reflectivity in the visible spectrum of more than 95%. Excitation takes place by blue laser light with a wavelength of 450 nm. The light emitted was measured spectrally by way of a spectrometer; for determining the color locus from the spectrum, the region starting from a wavelength of 465 nm is used.

For measuring the efficacy, the double-sidedly polished wafer or wafer rings of defined thickness were placed onto a mirror having a reflectivity in the visible spectrum of around 98%. Excitation takes place by blue laser light with a wavelength of 450 nm and a power of 3 mW.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An illumination device, comprising:
a light source configured for emitting a primary light;
a light conversion unit formed by or including a light conversion element including a front side and a back side, the light conversion element being configured for being illuminated with the primary light and for emitting a secondary light with a wavelength altered relative to the primary light, the light conversion element being configured, on illumination with the primary light, for emitting the secondary light which is characterized by a spectrum which defines a point in a CIE 1931 color space at least one of that:
(i) together with a blue point and a red point of an REC709 window defines an area which covers at least 95% of the REC709 window; and
(ii) has a radial distance from a green point of the REC709 window that is at most 0.02.

2. The illumination device according to claim 1, wherein the light source is configured for emitting the primary light which is a laser and which has a wavelength in a range from 400 nm to 460 nm.

3. The illumination device according to claim 1, wherein the light conversion element has a thickness extending from the front side to the back side, and wherein the thickness is between 50 μm and 250 μm.

4. The illumination device according to claim 1, wherein the light conversion element comprises a light-converting ceramic material.

5. The illumination device according to claim 4, wherein the light conversion element comprises a material (Lu₁₋ₓCeₓ)₃(Al_{1-y}Ga_{y})₅O₁₂, where 0<x<0.01 and 0<y<0.2.

6. The illumination device according to claim 1, wherein the light conversion element is configured for being illuminated with the primary light on the front side and for emitting the secondary light on the front side.

7. The illumination device according to claim 6, wherein the light conversion unit includes a substrate which is connected to the back side of the light conversion element and is formed as a heat sink, and wherein the light conversion unit further includes a connector located between the light conversion element and the substrate and connects them to one another.

8. The illumination device according to claim 1, wherein the light conversion element is configured for being illuminated with the primary light on the back side and for emitting the secondary light on the front side.

9. The illumination device according to claim 1, wherein at least one of the light conversion unit and the light conversion element is formed as a ring or a ring segment.

10. The illumination device according to claim 9, wherein at least one of the light conversion unit and the light conversion element is formed as a ring wafer and has an outer diameter which is larger than 30 mm and smaller than 120 mm.

11. The illumination device according to claim 1, wherein the light conversion unit has at least one highly reflective coating.

12. The illumination device according to claim 11, wherein the at least one highly reflective coating is at least one of a metallic coating, a dielectric coating, an Ag coating, or an Ag-containing coating.

13. The illumination device according to claim 1, wherein the light conversion element is configured for being illuminated with the primary light on the front side and for emitting the secondary light on the front side, wherein the light conversion unit includes a substrate which is connected to the back side of the light conversion element, wherein the light conversion unit further includes a connector located between the light conversion element and the substrate and connects them to one another, and wherein the connector is formed as a metallic solder, a sintered sinter paste, or an adhesive.

14. The illumination device according to claim 13, wherein the metallic solder has a melting point below 300° C. and comprises or consists of at least one of an Au/Sn solder and AuSn8020.

15. The illumination device according to claim 1, wherein the light conversion element comprises a plurality of pores.

16. The illumination device according to claim 15, wherein the light conversion element has a porosity of between 2% and 12%.

17. A light conversion unit, comprising:
a light conversion element including a front side and a back side, the light conversion element being configured for being illuminated with a primary light and for emitting a secondary light with a wavelength altered relative to the primary light, the light conversion element being configured, on illumination with the primary light in a range between 400 nm and 460 nm, for emitting the secondary light which is characterized by a spectrum which defines a point in a CIE 1931 color space that at least one of:
(i) together with a blue point and a red point of the REC709 window defines an area which covers at least 95% of the REC709 window; and
(ii) has a radial distance from a green point of the REC709 window that is at most 0.02.

18. The light conversion unit according to claim 17, wherein the light conversion unit includes a substrate which is connected to the back side of the light conversion element and is formed as a heat sink, wherein the light conversion unit further includes a connector located between the light conversion element and the substrate and connects them to one another.
